(19) United States
(12) Patent Application Publication
(10) Pub. No.: US 2011/0081635 A1
(43) Pub. Date: Apr. 7, 2011

(54) BIBLE READING BOOKMARK AND METHOD OF USING THE SAME

(76) Inventor: MONICA L. OLLIVIERRE, Stafford, VA (US)

(21) Appl. No.: 12/896,699

(22) Filed: Oct. 1, 2010

Related U.S. Application Data
(60) Provisional application No. 61/272,549, filed on Oct. 5, 2009.

(51) Int. Cl. G09B 19/00; B42D 9/00

(52) U.S. Cl. 434/245; 116/234

(57) ABSTRACT

The bible reading bookmark is a bookmark forming a substantially planar main body having opposed front and rear faces. Each of the front and rear faces is divided into a plurality of regions, with each region representing a distinct biblical passage. Front and rear sets of indicia are formed on the front and rear faces, respectively, of the substantially planar main body, the front and rear sets of indicia defining and separating the plurality of regions. Each of the regions includes indicia forming a checkbox, a name of a book of the bible, and a range of verses. In use, the user places the bookmark between adjacent pages of a bible corresponding to a selected bible passage. The user reads the selected bible passage and then forms a mark in the checkbox of the region corresponding to the selected bible passage upon completion of the selected bible passage.

### CROSS-REFERENCE TO RELATED APPLICATION

This application claims the benefit of U.S. Provisional Patent Application Ser. No. 61/272,549, filed Oct. 5, 2009.

### BACKGROUND OF THE INVENTION

1. Field of the Invention

The present invention relates to bookmarks and, particularly, for a bookmark to be used in education and recitation of biblical passages.

2. Description of the Related Art

The Bible is the central religious text of Judaism and Christianity. Modern Judaism generally recognizes a single set of canonical books known as the Tanakh, or Hebrew Bible, as it is written almost entirely in the Hebrew language, with some small portions in Aramaic. It is traditionally divided into three parts: the Torah (“teaching” or “law”), the Nevi'im (“prophets”), and the Ketuvim (“writings”). Christianity recognizes as canonical the books of the Tanakh, in a different order, as the Old Testament.

The Tanakh consists of 24 books. Tanakh is an acronym for the three parts of the Hebrew Bible: the Torah (“Teaching/Law” also known as the Pentateuch), Nevi'im (“Prophets”), and Ketuvim (“Writings,” or Hagiographa). The Torah, or “Instruction,” is also known as the “Five Books” of Moses, thus Chumash from Hebrew meaning “fivesome,” and Pentateuch from Greek meaning “five scroll-cases.” The Torah includes the following five books: Genesis, Exodus, Leviticus, Numbers, and Deuteronomy.

The Hebrew book titles come from the first words in the respective texts. The Hebrew title for Numbers, however, comes from the fifth word of that text. The Torah is divided into fifty-four portions that are read in turn in Jewish liturgy, from the beginning of Genesis to the end of Deuteronomy, each Sabbath. The cycle ends and recommences at the end of Sukkot, which is called Simchat Torah.

According to Jewish tradition, Nevi'im is divided into eight books. Contemporary translations subdivide these into seventeen books. The Nevi'im includes the following eight books: Joshua, Judges, Samuel, Kings, Isaiah, Jeremiah, and Ezekiel.

The Ketuvim includes the following eleven books: Psalms, Proverbs, Job, Song of Songs, Ruth, Lamentations, also called Kinot, Ecclesiastes, Esther, Daniel, Ezra, and Chronicles.

The Christian Bible consists of the Hebrew Scriptures, which have been called the Old Testament, and some later writings known as the New Testament. Different versions of the English Christian Bible include the KJV, the NKJV, and the NIV.

The Old Testament is the collection of books written prior to the life of Jesus but accepted by Christians as scripture. Broadly speaking, it is the same as the Hebrew Bible, however it divides and orders them differently, and varies from Judaism in interpretation and emphasis.

The Bible, as used by the majority of Christians, includes the Rabbinic Hebrew Scripture and the New Testament, which relates the life and teachings of Jesus, the letters of the Apostle Paul and other disciples to the early church and the Book of Revelation. The New Testament is a collection of 27 books, of four different genres of Christian literature (Gospels, one account of the Acts of the Apostles, Epistles and an Apocalypse). Jesus is its central figure. The New Testament was written primarily in Koine Greek in the early Christian period, though a minority argues for Aramaic primacy. Nearly all Christians recognize the New Testament as canonical scripture. These books can be grouped into: The Gospels, Synoptic Gospels, Gospel According to Matthew, Gospel According to Mark, Gospel According to Luke, Gospel According to John, Acts of the Apostles, Pauline Epistles, Epistle to the Romans, First Epistle to the Corinthians, Second Epistle to the Corinthians, Epistle to the Galatians, Epistle to the Ephesians, Epistle to the Philippians, Epistle to the Colossians, First Epistle to the Thessalonians, Second Epistle to the Thessalonians, Pastoral Epistles, First Epistle to Timothy, Second Epistle to Timothy, Epistle to Titus, Epistle to Philemon, Epistle to the Hebrews, General Epistles (also called Jewish Epistles), Epistle of James, First Epistle of Peter, Second Epistle of Peter, First Epistle of John, Second Epistle of John, Third Epistle of John, Epistle of Jude, and Revelation (or the Apocalypse).

Given the wide range of material, and the varying traditions and versions of the bible, teaching the bible is quite difficult. Thus, a bible reading bookmark and a method of using the same solving the aforementioned problems is desired.

### SUMMARY OF THE INVENTION

The bible reading bookmark is a bookmark forming a substantially planar main body having opposed front and rear faces. Each of the front and rear faces is divided into a plurality of regions, with each region representing a distinct biblical passage. Front and rear sets of indicia are respectively formed on the front and rear faces of the substantially planar main body, with the front and rear sets of indicia defining and separating the plurality of regions. Each of the regions includes indicia forming a checkbox, a name of a book of the bible, and a range of verses. Preferably, the plurality of regions is arrayed sequentially, based upon respective books of the bible and the corresponding ranges of verses.

In use, the user places the bookmark between adjacent pages of a bible corresponding to a selected bible passage. The user reads the selected bible passage and then forms a mark in the checkbox of the region corresponding to the selected bible passage upon completion of the selected bible passage. The mark indicates that this bible passage has been read, and indicates to the user which biblical passage is to be read next.

These and other features of the present invention will become readily apparent upon further review of the following specification and drawings.

### BRIEF DESCRIPTION OF THE DRAWINGS

FIG. 1 is an environmental, perspective view of a bible reading bookmark according to the present invention.

FIG. 2 is a plan view of a front face of the bible reading bookmark according to the present invention.

FIG. 3 is a plan view of a rear face of the bible reading bookmark according to the present invention.

Similar reference characters denote corresponding features consistently throughout the attached drawings.

### DETAILED DESCRIPTION OF THE PREFERRED EMBODIMENTS

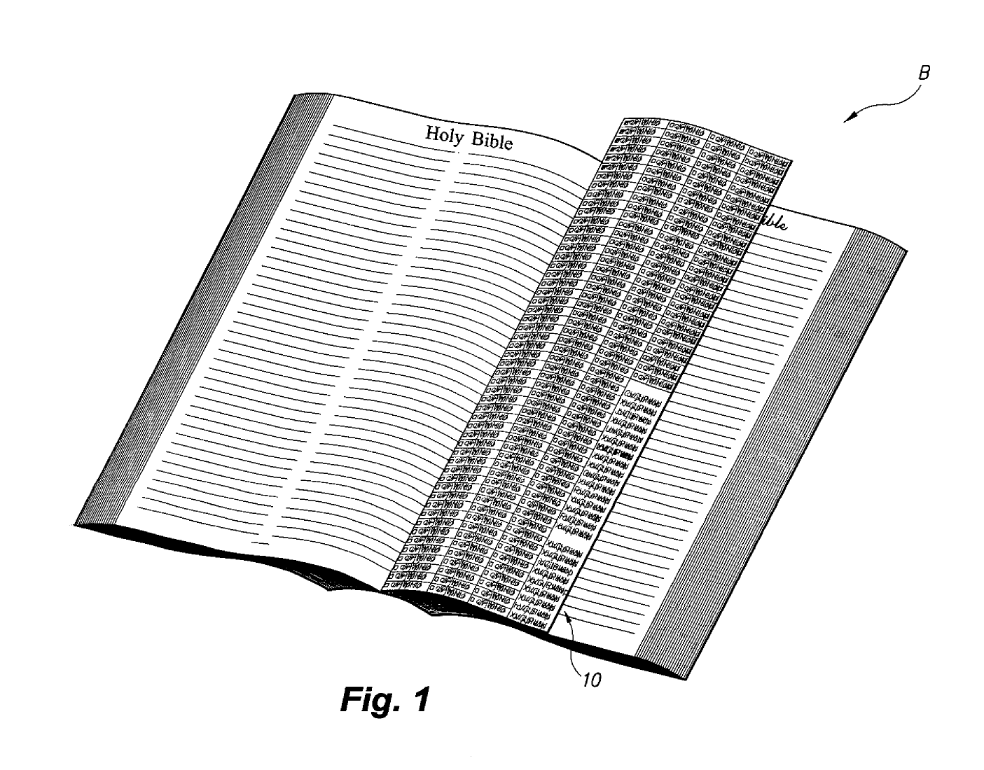

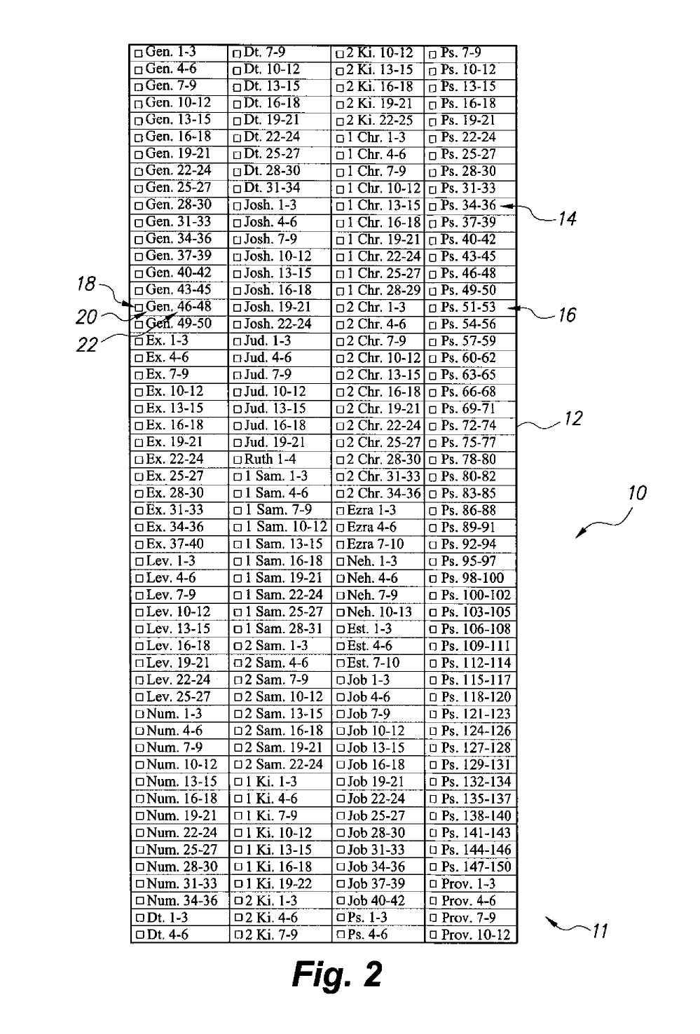

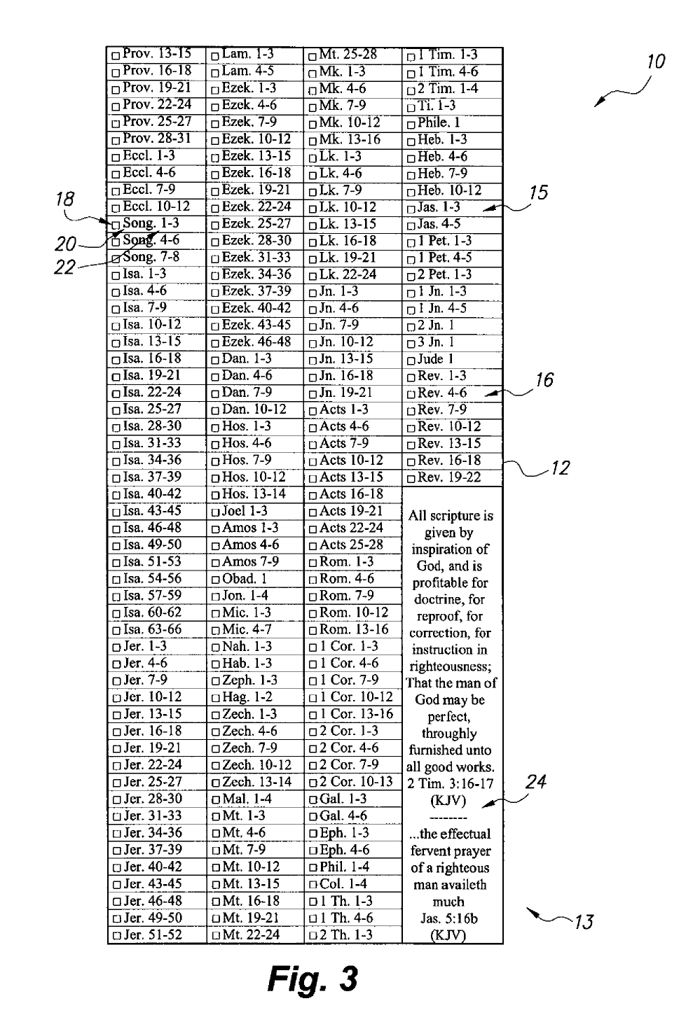

Referring to FIG. 1, the bible reading bookmark 10 is a bookmark for use with a bible B or other text having passages that are typically read in sequence. As best shown in FIGS. 2 and 3, the bookmark 10 is formed as a substantially planar main body 12, having opposed front and rear faces 11, 13, respectively. Each of the front and rear faces 11, 13 is divided into a plurality of regions 16, with each region 16 representing a distinct biblical passage (or other division of text, depending upon the nature of the book or text the bookmark 10 is used with).

Front and rear sets of indicia 14, 15, respectively, are respectively formed on the front and rear faces 11, 13 of the substantially planar main body 12, with the front and rear sets of indicia 14, 15 defining and separating the plurality of regions 16. Each of the regions 16 include indicia forming a checkbox 18, a name of a book of the bible 20 (shown in FIGS. 2 and 3 as being abbreviated names, though it should be understood that any suitable type of typography, font, size or naming system may be used), and a range of verses 22 (indicated in FIGS. 2 and 3 as a numerical range). Preferably, the plurality of regions 16 are arrayed sequentially based upon respective books of the bible 20 and the corresponding ranges of verses 22. It should be noted that any desired range of verses 22 may be utilized, and FIGS. 2 and 3 illustrate exemplary ranges only. Additionally, it should be understood that any suitable type of typography, font, size or naming system may be used with the ranges of verses 22. Dependent upon available space and the desires of the user, selected biblical passages and quotes 24 may also be printed on the bookmark 10 (shown printed on rear face 13 in FIG. 3). It should be understood that passages, quotes and/or any other desired indicia may be varied, dependent upon the particular needs and desires of the user. FIG. 3 illustrates exemplary indicia only.

As shown, the bookmark 10 preferably has a substantially rectangular contour, similar in dimensions and contouring to a conventional bookmark. Exemplary dimensions include a width of approximately 3¾ inches and a length of approximately 8½ inches. It should be understood that bookmark 10 may have any desired contouring or relative dimensions, dependent upon the particular needs of the user. Further, each region 16 is preferably rectangular, with the regions being sequentially formed in a regular, rectangular array, though it should be understood that the overall layout of regions 16 may be varied, dependent upon the particular needs of the user. The main body 12 may be formed from recycled cardstock or any other suitable material, as is conventionally known in the art of bookmarks. Similarly, indicia 14, 15 may be formed by any suitable process, such as printing or the like, as is conventionally known in the arts of bookmarks and card printing.

In use, the user places the bookmark 10 between adjacent pages of a bible 10, corresponding to a selected biblical passage. The user reads the selected biblical passage and then forms a mark in the checkbox 18 of the region 16 corresponding to the selected bible passage upon completion of the selected bible passage. The mark formed in checkbox 18 indicates that this bible passage has been read, and indicates to the user which biblical passage is to be read next.

It is to be understood that the present invention is not limited to the embodiments described above, but encompasses any and all embodiments within the scope of the following claims.

I claim:

1. A bible reading bookmark, comprising a substantially planar main body having opposed front and rear faces, the front and rear faces having a plurality of regions defined thereon, each of the regions representing a distinct biblical passage.

2. The bible reading bookmark as recited in claim 1, further including front and rear sets of indicia formed on the front and rear faces, respectively, of said substantially planar main body, the front and rear sets of indicia defining and separating the plurality of regions.

3. The bible reading bookmark as recited in claim 2, wherein each said set of indicia includes a name of a book of the bible.

4. The bible reading bookmark as recited in claim 2, wherein each said set of indicia includes a checkbox.

5. The bible reading bookmark as recited in claim 2, wherein each said set of indicia includes an indication of a range of verses of a book of the bible.

6. A bible reading bookmark, comprising a substantially planar main body having opposed front and rear faces, the front and rear faces having a plurality of regions defined thereon, each of the regions representing a distinct biblical passage; and
front and rear sets of indicia formed on the front and rear faces, respectively, of the substantially planar main body, the front and rear sets of indicia defining and separating the plurality of regions, each of the sets of indicia including a corresponding name of a book of the bible.

7. The bible reading bookmark as recited in claim 6, wherein each of the sets of indicia includes a checkbox.

8. The bible reading bookmark as recited in claim 6, wherein each of the sets of indicia includes an indication of a range of verses of a book of the bible.

9. The bible reading bookmark as recited in claim 6, wherein each of the sets of indicia includes a checkbox and an indication of a range of verses of a book of the bible.

10. The bible reading bookmark as recited in claim 9, wherein the plurality of regions are arrayed sequentially based upon respective books of the bible, and the ranges of verses corresponds with the corresponding respective book.

11. A method of teaching bible passages, comprising the steps of:
providing a bookmark having opposed front and rear faces;
dividing each of the front and rear faces of the bookmark into a plurality of regions, each of the regions representing a distinct biblical passage;
forming front and rear sets of indicia on the front and rear faces, respectively, of the bookmark, the front and rear sets of indicia defining and separating the plurality of regions, each of the regions including indicia forming a checkbox, a name of a book of the bible, and a range of verses;
placing the bookmark between adjacent pages of a bible corresponding to a selected bible passage;
reading the selected bible passage; and
forming a mark in the checkbox of the region corresponding to the selected bible passage upon completion of the selected bible passage.
